(19) United States
(12) Patent Application Publication
(10) Pub. No.: US 2012/0169556 A1
(43) Pub. Date: Jul. 5, 2012

(54) BROADBAND MULTI-FREQUENCY MONOPOLE FOR MULTI-BAND WIRELESS RADIO

(75) Inventor: Robert Truthan, Cuyahoga Falls, OH (US)

(73) Assignee: ELECTRO-MAGWAVE, INC., Valley View, OH (US)

(21) Appl. No.: 13/338,427

(22) Filed: Dec. 28, 2011

Related U.S. Application Data
(60) Provisional application No. 61/428,166, filed on Dec. 29, 2010.

(51) Int. Cl. H01Q 9/06

(52) U.S. Cl. 343/752

(57) ABSTRACT

A top load multi-band monopole antenna is utilized with an integrated resonator to achieving broad band and multiband performance for multiple frequency spectrums. The top loaded monopole antenna can utilize a low frequency band (e.g., approximately 700/800/900 MHz) and a high frequency band (e.g., approximately 1900 MHz to approximately 1500 MHz) by implementation of the resonator. The resonator matches an impedance of the upper portion of the top loaded monopole antenna for capabilities in a high frequency range without interference from any low frequency range.

### CROSS-REFERENCE TO RELATED APPLICATIONS

This application claims the benefit of U.S. Provisional Patent Application No. 61/428,166, filed Dec. 29, 2010, and entitled “BROADBAND MULTI-FREQUENCY MONOPOLE FOR MULTI-BAND WIRELESS RADIO.” The entirety of the aforementioned application is incorporated herein by reference.

### BACKGROUND

In order to maintain an organized structure with the broad spectrum of wireless frequencies, governments typically allocate frequencies. Wireless communications typically utilize specific frequency ranges based on the type of device or specific type of use. For example, one frequency range can be allocated for cellular communications, whereas a second frequency range can be allocated for Personalized Communication Service (PCS). In particular, 746-870 MHz is allocated to Public Safety and/or Land Mobile Radio; 806-894 MHz is allocated to Specialized Mobile Radio (SMR) and Cellular 800; 894-960 MHz is assigned to Industrial, Scientific and Medical (ISM) and Unlicensed Bands; and 1850-1990 MHz is allocated to PCS 1900.

Traditional monopole antennas are implemented in a variety of configurations for ground plane dependent wireless radio applications. Monopole radiators (e.g., monopole antennas) are often referred as “quarter-wave” antennas due to their characteristic requirement of their physical length approximating ¼ (e.g., quarter) wavelength at the desired frequency of operation, and are considered to be one of the most fundamental structures to achieve efficient omnidirectional Radio Frequency (RF)/Microwave radiation. Monopoles also provide reasonably broad band performance relative to their desired operational frequency, and can be designed for efficient radiation in excess of 25% to 30% of total operational bandwidth.

Monopoles can be comprised of a conductive thin diameter wire radiator (primary conductor) oriented in a vertically normal position with respect to a close proximity conductive ground plane surface (secondary conductor). The ground plane is typically several wavelengths in diameter or infinitely sized for theoretical considerations. RF voltage is applied across the two conductors through a small isolated feed point near the center of the ground plane. It is important to note that the monopole antenna cannot physically exist without the ground plane. The ground plane is an integral part of the monopole impedance and radiation characteristics. Theoretically, the monopole is defined by its quarter-wave length size emanating from the existence of an infinite (very large) ground plane and defined by image theory of a virtual source on the opposite side of the ground plane, establishing dipole like characteristics.

Designing the monopole requires a design methodology to implement a vertical radiator approximating the desired ¼ wavelength structure, and is a well known practice to those skilled in the art of antenna design. Furthermore, enhancing the bandwidth, radiation efficiency and reducing the physical height (length) of the monopole enable great flexibility in their employment.

A common design implementation includes top loading the monopole by physically increasing the diameter of the primary conductor at the highest point (maximum RF voltage) which effectively reduces the total physical height while simultaneously increasing the electrical length. The top load implementation results in a shorter physical radiator, operating at a lower and much broader RF frequency range. Other bandwidth enhancing techniques include increasing the physical diameter of the primary conductor, in affect decreasing the Length-to-Diameter (L/D) ratio with a benefit to reducing the total physical height and increasing operational bandwidth.

Mobile antennas and specifically, mobile monopole antennas are prominently utilized in various arenas. For example, mobile antennas are employed in the areas of Land Mobile Radio (LMR), public safety, homeland security, cellular, telematics, telemetry, in-building, portable applications, and the like. Such mobile antennas can be mounted using a physical mount to a surface or a magnet temporarily attached to a surface, etc. Yet, one mount technique has come to fruition as a standard for mobile antennas. In particular, the New Motorola™ (NMO) mount (herein referred to as the NMO mount) has become the industry standard for mobile antenna mounts, specifically mounting mobile antennas to automobiles. However, the NMO mount has performance issues with higher frequencies due to signal reflection which tends to cause problems when the NMO mount is used with frequencies higher than 1 GHz.

Since the NMO mount is standardized and utilized throughout the mobile antenna industry, this can lead to many complications in attempts to extend monopole antennas to different frequency spectrums such as a lower frequency and a higher frequency (e.g., above 1 GHz). Furthermore, mobile antenna consumers benefit from having mobile antennas compatible across multiple frequency spectrums. However, based on the complications surrounding the NMO mount, options are limited in order to utilize a mobile antenna with an NMO mount while communicating with low and high frequencies. Solutions are often costly and complicated since multiple antennas and mounts are typically implemented.

### SUMMARY

The following presents a simplified summary of the innovation in order to provide a basic understanding of some aspects described herein. This summary is not an extensive overview of the disclosure subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

In brief, the subject disclosure generally pertains to an antenna that operates within a low frequency band and a high frequency band. The antenna can be a top loaded monopole antenna that includes a resonator to match impedance with an upper portion of the top loaded monopole antenna for a high frequency signal (e.g., above 1 GHz). By matching the impedance with the resonator, the antenna can radiate and receive a low frequency signal and a high frequency signal without interference from one another. Furthermore, the top loaded monopole antenna and/or the resonator can further be adjusted (e.g., materials, size, ratios, etc.) to target specific frequencies within both a low band of frequencies and a high band of frequencies.

The following description and the annexed drawings set forth in detail certain illustrative aspects of the subject disclosure. These aspects are indicative, however, of but a few of the various ways in which the principles of the innovation may be employed and the claimed subject matter is intended to include all such aspects and their equivalents. Other advantages and novel features of the subject disclosure will become apparent from the following detailed description of the innovation when considered in conjunction with the drawings.

### BRIEF DESCRIPTION OF THE DRAWINGS

FIG. 1 is a diagram of an antenna that facilitates multi-band communication.

FIG. 2 illustrates a cross section view of an antenna and housing.

FIG. 3 illustrates a top view of a resonator.

FIG. 4 illustrates an aperture associated with a resonator.

FIG. 5 illustrates a side view of a threaded support bushing.

FIG. 6 illustrates a top view of a threaded support bushing.

FIG. 7 illustrates a side view of a traditional NMO mount for an antenna.

FIG. 8 illustrates an antenna within a radome housing and an antenna mount.

FIG. 9 is a flow chart diagram of a method of communicating multi-band frequencies.

FIG. 10 is a flow chart diagram of a method of matching impedance in order to operate an antenna in a high frequency band and a low frequency band.

FIG. 11 is a flow chart diagram of a method of customizing a top loaded monopole antenna to operate within a specific high frequency and a specific low frequency.

FIG. 12 is an illustration of a wireless communication system.

### DETAILED DESCRIPTION

Details below are generally directed toward a top loaded monopole antenna that handles (e.g., operates within) a lower band of frequencies and a higher band of frequencies. In particular, a top loaded monopole is disclosed that utilizes a resonator that enables a low band frequency (e.g., approximately 700 MHz to approximately 960 MHz) and a high band frequency (e.g., approximately 1 GHz to approximately 2.5 GHz) to be radiated and/or received. The resonator placement in connection with the top loaded monopole antenna allows receipt and/or transmission of a low frequency signal on the entire top loaded monopole antenna (e.g., radiator element and radiator cap). Moreover, the resonator enables the top loaded monopole antenna to receive and/or transmit a high frequency signal above the resonator to the upper portion of the top loaded monopole antenna based upon the resonator matching an impedance of the upper portion of the top loaded monopole antenna (e.g., radiator cap). The top loaded monopole antenna and the resonator provide an antenna capable of receiving and/or transmitting dual bands of frequencies and in particular, a high frequency signal (e.g., above approximately 1 GHz) and a low frequency signal (e.g., below approximately 1 GHz). Conventional techniques leverage a choke that filters or eliminates current for high frequency signals. However, such choke techniques do not completely eliminate current but rather attempt to essentially eliminate current. Yet, the choke and conventional techniques do not completely eliminate or filter as remnants (e.g., remainders) of the current still exists in such antennas. On the contrary, the resonator matches impedance for high frequencies allowing current to pass-through rather than attempting to eliminate or filter such current (e.g., utilizing a choke). In other words, rather than utilizing a choke to filter or effectively eliminate current (e.g., where such current still exists and is not eliminated), a resonator allows the current to pass-through. The resonator and pass-through current design afford greater optimization of antennas when compared to conventional choke techniques.

The subject disclosure is described with reference to the drawings, wherein like reference numerals are used to refer to like elements throughout. In the following description, for purposes of explanation, numerous specific details are set forth in order to provide a thorough understanding of the subject innovation. It may be evident, however, that the subject disclosure may be practiced without these specific details. In other instances, well-known structures and devices are shown in block diagram form in order to facilitate describing the subject disclosure.

Moreover, the word “exemplary” is used herein to mean serving as an example, instance, or illustration. Any aspect or design described herein as “exemplary” is not necessarily to be construed as preferred or advantageous over other aspects or designs.

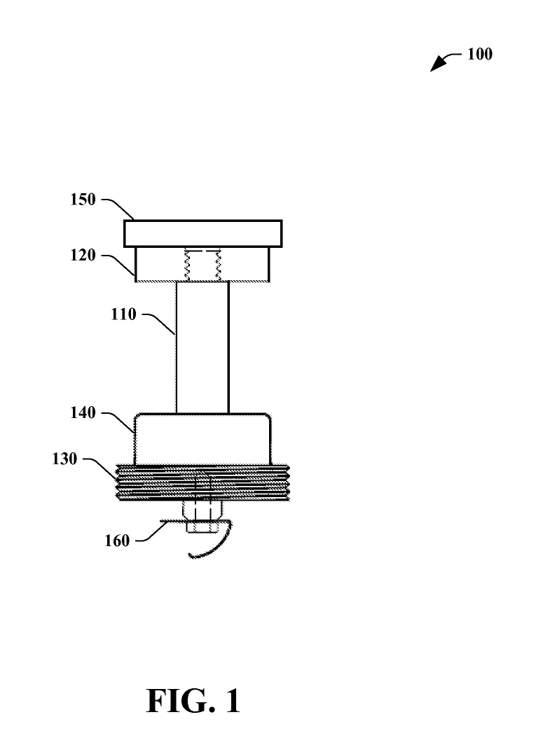

Now turning to the figures, FIG. 1 illustrates an antenna 100 that facilitates multi-band communication. The antenna 100 matches impedance with a high frequency signal in order to provide dual band frequency operation with a low frequency signal below approximately 1 GHz and a high frequency signal above approximately 1 GHz. In particular, the antenna 100 incorporates a resonator 140 that enables dual band frequency operation within a low frequency (e.g., approximately 700 MHz to approximately 960 MHz) and a high frequency (e.g., approximately 1 GHz to approximately 2.5 GHz).

The antenna 100 includes a contact 160 that provides electrical connectivity to a radiator element 110. The radiator element 110 is electrically coupled to a radiator cap 120 such that the radiator element 110 and the radiator cap 120 create a top loaded monopole antenna structure. A threaded support bushing 130 is attached to a lower portion of the radiator element 110 for structural support, electrical isolation between the radiator element 110 and a radome housing (not shown and discussed below) as well as dielectric loading. The resonator 140 is affixed on an upper portion of the threaded support bushing 130 such that the resonator 140 covers an entire upper portion of the threaded support bushing 130. The antenna 100 further includes a compression pad 150 (e.g., also referred to as low density foam with adhesive) that ensures mechanical support and low density dielectric electrical isolation between the radiator cap 120 and the radome housing.

The antenna 100 allows simultaneous transmission and/or receipt of a high frequency signal and a low frequency signal based upon a broadband impedance match provided by the resonator 140. The resonator 140 supports half wave radiation due to the nature of the shape, geometry, and location on the antenna 100. The resonator 140 can divert current inside and around the radiation element 110 of the antenna 100. For a high frequency signal, the resonator 140 and antenna 100 resonates because of the half-wave length resonance that is achieved between the radiator cap 120 and the resonator element 140 of the antenna 100. In particular, the resonator 140 matches impedance for a high frequency signal allowing the transmission and receipt of high frequency signals without any interference from low band frequencies. The resonator 140 matches the impedance for the radiator cap 120 (e.g., the upper portion of the top loaded monopole antenna 100). Moreover, the resonator 140 can also match impedance for an antenna mount (not shown) (e.g., an NMO mount, etc.). The resonator 140 can match impedance for the antenna mount as well as the radiator cap 120 based upon the composite structure of the resonator 140, size of the resonator 140, and the dielectric materials utilized with a radome housing (not shown) that encases the antenna 100.

For example, a conventional technique utilizes a choke that attempts to filter or eliminate current flow to an upper portion of a top loaded monopole antenna. However, such techniques do not fully eliminate the current and a leak of current exists which typically interferes with receipt and/or transmissions with the top loaded monopole antenna. Yet, by utilizing the resonator 140 with the radiator element 110, the radiator cap 120, and the threaded support bushing 130, an impedance of the radiator cap 120 is matched to allow for radiation and/or receipt of high frequency signals without interference from a low band of frequency signals. In particular, the resonator 140 separates the high frequency signal between the resonator 140 and the radiator cap 120 while the low frequency signal is between the contact 160 to the radiator cap 120.

The subject disclosure includes the resonator 140 which is attached to the primary conductor/radiator (e.g., radiator element 110). The resonator 140 provides for an optimal feed point impedance match and current flow to the upper portion of the radiator element 110 (e.g., radiator cap 120), where approximate half-wavelength resonance and radiation is achieved. Conventional techniques typically attempt to filter or eliminate current with a choke but current is not completely eliminated or filtered. However, the subject disclosure employs the resonator 140 that allows current to pass-through to enable multi-frequency capabilities.

The subject disclosure is specifically intended for broad, dual band operation. The antenna 100 is configured to operate across an extended broad range of frequencies in the lower band region and conjunctively in a higher frequency band, approximately double the frequency of the lower band. In general, the antenna 100 can be configured to operate in a low frequency band and a high frequency band in which the high frequency band is approximately 1.9 to approximately 3.0 times the lowest frequency of operation. For example, a configuration can include a simultaneously operation in a dual band mode operating in the vicinity of approximately 850 MHz and approximately 1900 MHz. In general, the antenna 100 can operate in a low frequency band (e.g., approximately 700 MHz to approximately 960 MHz) and a high frequency band (e.g., approximately 1 GHz to approximately 2.5 GHz).

Quarter-wave monopole structures are typically designed for broad, single band operation and are easily implemented across the lower band of interest, approximately 746 MHz to approximately 960 MHz. This lower band broad range of frequencies encompasses many mobile radio bands and applications, making the typical broad band quarter-wave widely used and accepted for broad or multi-band systems, where the range of frequencies are nearly continuous (e.g., narrow band gaps only) and relatively close together within the Radio Frequency (RF) spectrum. The antenna 100 operates across a broad range of closely spaced bands (approximately 746 MHz to approximately 960 MHz) including operation at a higher band (approximately 1850 MHz to approximately 1990 MHz), where several mobile radio systems are operated by carriers who own spectrum in both the lower and upper bands of interest.

The antenna 100 achieves the required performance by incorporation of a resonator device (e.g., also referred to as the resonator 140) that augments a dual resonant impedance match with highly efficient radiation characteristics in both the lower and upper bands of frequencies. The resonator 140 is unique in providing optimized impedance match for the upper band of frequencies while insignificantly impacting the impedance match of the lower band of frequencies. Additionally, the resonator 140 provides support for approximate half-wave radiation characteristics in the upper band of frequencies while not requiring a ground plane (which is typically required for quarter-wave monopole implementation). The antenna 100 radiates efficiently within the lower band of frequencies.

Additionally, the antenna 100 is optimized for impedance matching with traditional antenna mounts (e.g., NMO mount, among others) widely used and accepted throughout the mobile radio industry, whereas such traditional mounts have proved difficult to impedance match in dual band modes including operational frequencies above approximately 1000 MHz (e.g., 1 GHz).

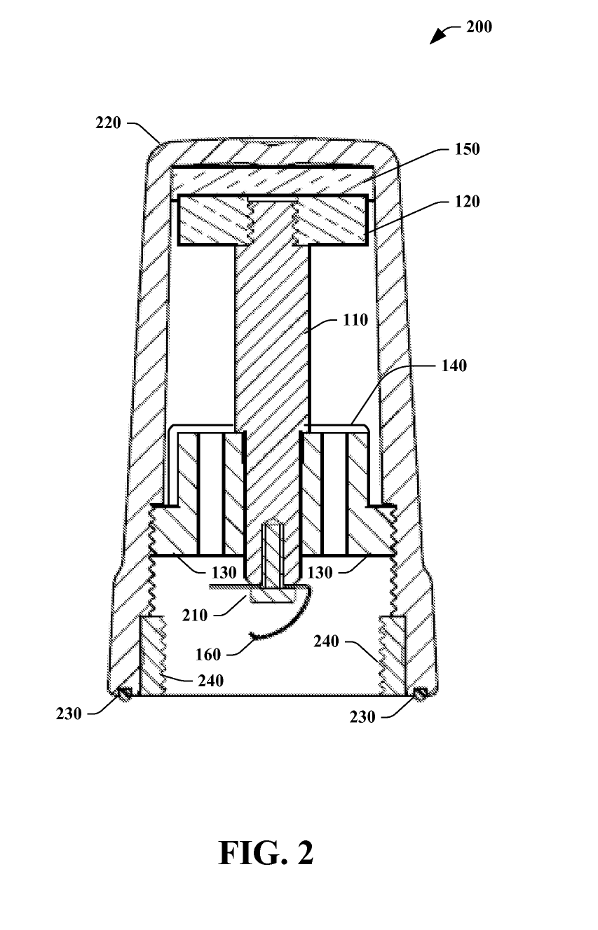

FIG. 2 illustrates a cross section view of an antenna and radome housing 200. The antenna and radome housing 200 enable the simultaneous transmission and/or reception of dual band frequencies. In particular, the antenna and radome housing 200 allow a low frequency and a high frequency to be radiated and/or received without interference between the two bands. For example, the antenna and housing 200 can handle a low frequency between approximately 700 MHz to approximately 900 MHz (e.g., low frequency) as well as a high frequency above approximately 1 GHz (e.g., approximately 1 GHz to approximately 2.5 GHz).

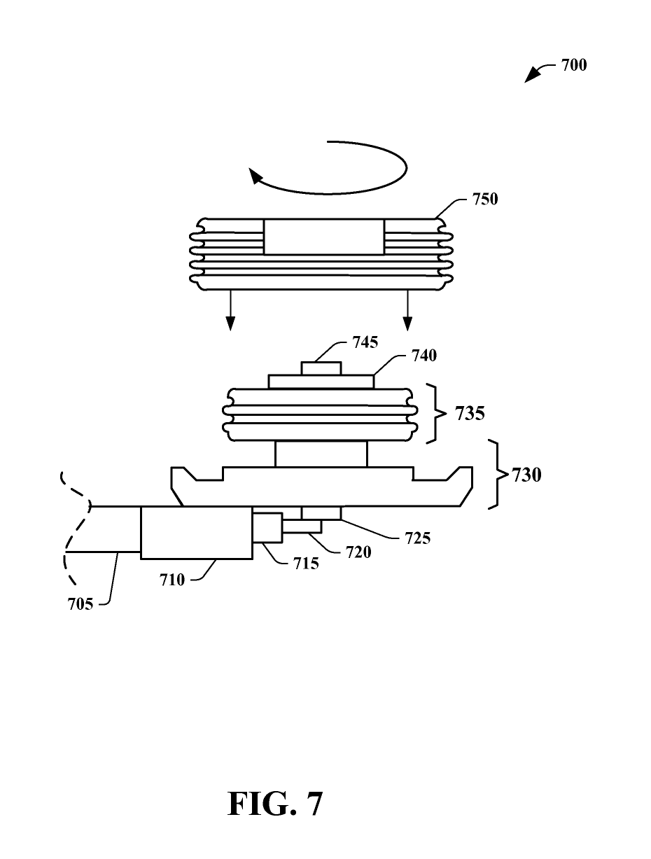

The contact 160 can be an initial electrical conductive feed point for the antenna and radome housing 200, wherein the contact 160 can be comprised of a resilient conductively plated brass copper alloy providing a high degree of mechanical spring-like retention between the antenna mount contact pin (not shown and discussed in FIG. 7) and the primary conducting radiator element 110. A hex cap screw 210 can provide mechanical attachment and ensures continuous electrical conductivity between the contact 160 and the radiator element 110.

A threaded support bushing 130 can provide mechanical location, structural integrity, and electrical isolation between the radiator element 110 and a radome housing 220. Additionally, the threaded support bushing 130 can employ dielectric loading between the resonator 140 and radiator element 110, while maintaining mechanical support between the resonator 140 and the radiator element 110. The threaded support bushing 130 locates and affixes the antenna radiating structure (e.g., the radiator cap 120, the radiator element 110, the resonator 140, and the compression pad 150) to and within the radome housing 220. The threaded support bushing 130 can be machined from, for example, Polyoxymethylene (POM) material (also referred to as Delrin™). It is to be appreciated that the threaded support bushing 130 can be constructed from any suitable material to manage the mechanical location, structural integrity, electrical isolation between the radiator element 110 and the radome housing 220, and the dielectric loading between the resonator 140 and the radiator element 110.

The radiator element 110 is the primary conductive element, supporting current flow and radiation for both the low frequency (e.g., approximately 700/800/900 MHz) and high frequency (e.g., approximately 1900 MHz to approximately 2500 MHz) bands. By way of example and not limitation, the radiator element 110 can be conductively plated brass, copper alloy, and/or any other suitable material related to primary conductive elements. The radiator cap 120 provides a top loaded monopole characteristic for broad band electrical performance and low profile mechanical aesthetic characteristics. It is to be appreciated that the radiator cap 120 can be conductively plated brass, copper alloy, and/or any other suitable material related to primary conductive elements. The radiator cap 120 can function in unison with the radiator element 110 to provide an overall electrical current flow and radiation characteristics for both low and high frequency bands (e.g., approximately 700/800/900 MHz and approximately 1900 MHz to approximately 2500 MHz).

The resonator 140 provides the conductivity, impedance match and half-wave resonance to operate the antenna 200 at the higher frequency bands (e.g., PCS 1900 MHz, 2500 MHz, among others). The resonator 140 is conductively attached to the radiator element 110 by incorporating a press fit, spring-like retention feature within an inner diameter (ID) of the resonator 140. The conductive brass copper alloy is chosen appropriately to provide continual mechanical retention and electrical contact with the radiator element 110 without interruption to electrical current flow. The electrical contact between the resonator 140 and the radiator element 110 provides a short circuit condition, forcing current to flow in and around the resonator 140 and onto the upper portion of the radiator element 110. The resonator 140 is dimensioned to support the required electrical performance characteristics. Dielectric loading is employed to optimize the electrical current phase and increase operational wavelength of the current flowing within the resonator 140. This condition optimizes the impedance match while permitting the current to flow onto the upper portion of the radiator element 110.

The following are exemplary dimensions of the resonator 140. It is to be appreciated that the dimensions and materials of the resonator 140 and associated components (e.g., compression pad 150, radiator cap 120, radiator element 110, threaded support bushing 130, radome housing 220, and the like) can be adjusted and changed (discussed in more details below) based on desired frequency bands, size dimensions of the antenna, and the like. By way of example and not limitation, the resonator 140 can be comprised of a thin walled brass copper alloy material with a nominal length of approximately 9.3 mm and outer diameter (OD) of approximately 24.9 mm and inner diameter (ID) of approximately 24.3 mm. A resonator L/D ratio of approximately 0.37 nominal in conjunction with Polyoxymethylene (POM) material (also referred to as Delrin™), dielectric loading provides optimal current flow and impedance matching for both low frequency bands (e.g., 700/800/900 MHz) and high frequency bands (e.g., 1900 MHz, 2500 MHz, among others) when affixed to the primary radiator element 110 of approximately 7 mm diameter on the lower portion of radiator element 110 and approximately 9.5 mm diameter on the upper portion of the radiator element 110 (e.g., radiator cap 120). Other dimensional variations are possible with proper selection of dielectric constant for optimal phasing and choice of the radiator element 110 diameter. The antenna 200 utilizes a particular ratio for an inside diameter (ID) of the resonator 140 to outside diameter (OD) of the radiator element 110 for optimal performance. For instance, the ratio between the resonator 140 ID to the radiator element 1100D ratio can be in the range of approximately 3.45 to approximately 3.55. Other designs operating at scalable frequencies are achievable using scalable dimensions with similar ratios for the resonator 140, radiator element 110 and the threaded support bushing 130.

The vertical location of the resonator 140 is determined to be optimal at approximately 19.7 mm from the feed point location referenced between the contact 160 and radiator element 110 interface location. Variations in vertical displacement from the antenna 200 location can alter the tuned range of achievable frequencies in the upper band of frequencies. Increasing or decreasing this height location can cause the tunable band to adjust lower in frequency or higher in frequency range. The result is dependent upon the actual dimensional location. In other words, the antenna 200 can be customizable for a low band of frequency and a high band of frequency by adjusting at least one of the vertical location of the resonator 140, the dielectric constant (e.g., material of the threaded support bushing 130), and the ratio between the ID and OD of the resonator and the OD of the radiator element 140.

Compression pad 150 provides mechanical support and low density dielectric electrical isolation between the radiator cap 120 and radome housing 220. An o-ring 230 can provide an environmental seal between internal critical electrical components (e.g., encased within the radome housing 220) and the exterior environment. The o-ring 230 protects while under compression between the radome housing 220 and the installation ground plane surface (not shown). An insert thread 240 can provide a threaded installation interface between the antenna 200 and a threaded mount (not shown but discussed in FIG. 7). In particular, the insert thread 240 can be a threaded installation interface between the antenna 200 and any suitable mount such as, but not limited to, an NMO mount, an NMO threaded antenna mount, among others (e.g., discussed in FIG. 7). The insert thread 240 can be assembled by press fit and ultrasonic welding process within the radome housing 220. By way of example and not limitation, the radome housing 220 can be injection molded non-conductive dielectrically optimized protective enclosure made from plastic alloys for mechanical strength, environmental resistance and efficient low loss radiation characteristics. It is to be appreciated that any suitable material and construction techniques can be employed with the antenna 200, the radome housing 220, and the insert thread 240 and the above techniques are not to be limiting on the subject disclosure.

The antenna 200 can be matched for broadband frequency operation by using a top loaded monopole (e.g., radiator cap 120 and radiator element 110) in combination with the resonator 140. The physical diameter ratio (D/d) of the top loaded monopole (e.g., radiator cap 120) to radiator element can be approximately 2.5 to approximately 2.6. The antenna 200 can include the resonator 140 for operation at higher frequency bands, typically on the order of approximately 1.9 to approximately 3.0 times the lowest frequency of operation. For example, if the lowest frequency is 700 MHz, the higher frequency band can be approximately 1330 MHz to approximately 2100 MHz. The antenna 200 integrates the resonator 140 to achieve impedance match for operation at higher frequency bands, operating in conjunction, and typically on the order of 1.9 to 3.0 times the lowest frequency of operation. The antenna 200 exhibits broadband frequency impedance matching at the higher frequency band of operation, with the resonator 140 physical diameter being, for example, on the order of approximately 3.0 to approximately 3.8 times the radiator cap 120 physical diameter.

The antenna 200 can include dielectric loading of the resonator 140 to achieve the physical diameter dimensions. The antenna 200 includes dielectric loading of the resonator 140 to achieve the electrical/RF impedance match at the higher frequency band. The antenna 200 can be specifically matched for traditional low impedance antenna mounts. For example, the traditional low impedance antenna mount can be a “Type N Motorola™” (NMO). The antenna 200 can be specifically optimized for impedance match for standard 50 Ohm impedance antenna mounts. The antenna 200 produces half-wave resonant radiation at the upper frequency band while maintaining singular element quarter-wave monopole type radiation characteristics at the lower frequency band. The antenna 200 establishes a first said frequency source of radiation between a drive input and the radiator cap 120 and a second said frequency source of radiation between the resonator 140 and a top load (e.g., radiator cap 120). The antenna 200 utilizes a conductive ground plane for impedance matching at the lower frequency bands of operation. Furthermore, the antenna 200 exhibits matched impedance characteristics independent of a ground plane for the upper frequency band of operation. Moreover, the antenna 200 constructed as described herein using materials suitable for the application of elevated RF power, when operating up to, but not limited to, 100W continuously.

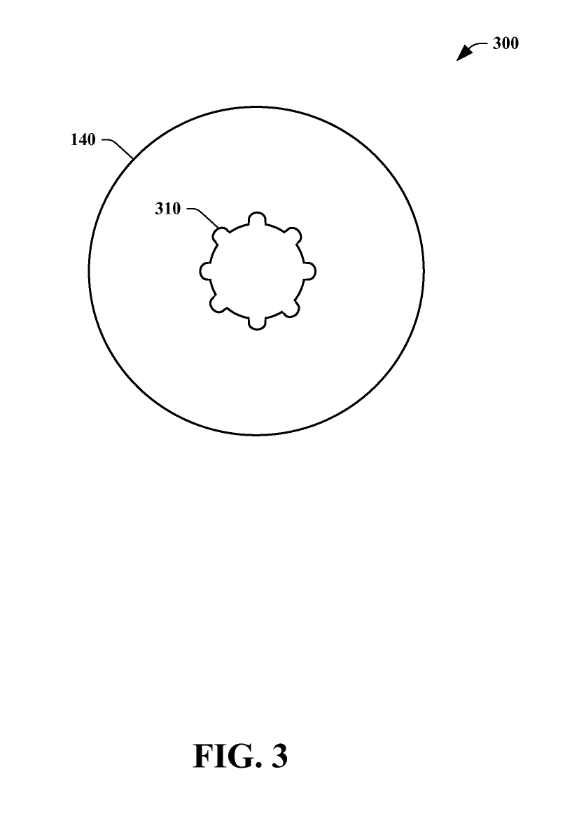

FIG. 3 illustrates a top view 300 of the resonator 140. The resonator 140 is illustrated from a top view 300 in FIG. 3. The resonator 140 is illustrated from the top view 300 that depicts an aperture 310. As discussed, the resonator 140 is constructed with a specific diameter and material in order to match an impedance of a top portion of a top loaded monopole antenna (e.g., the radiator cap 120 as discussed above in FIGS. 1 and 2).

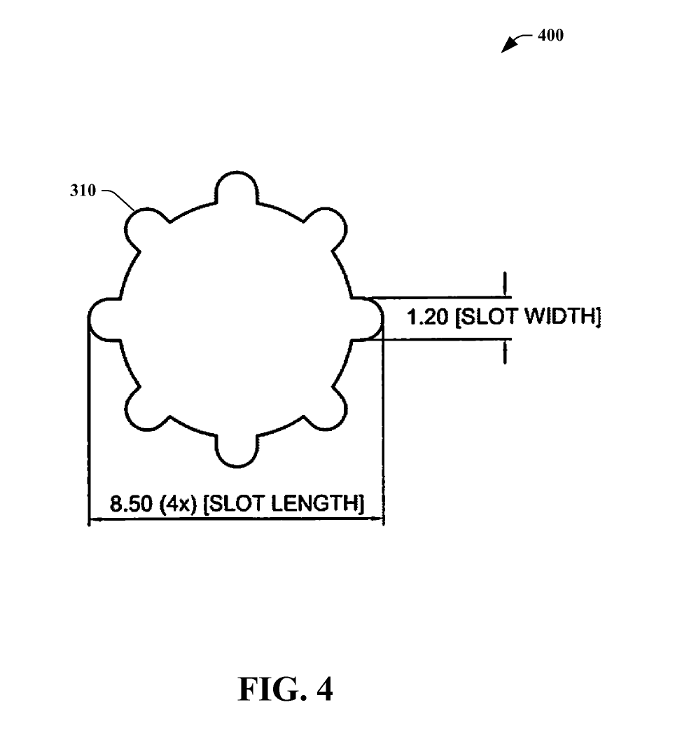

The resonator 140 includes the aperture 310 to which the radiator element 110 (not shown but discussed in FIGS. 1 and 2) is inserted. In other words, the radiator element 110 is inserted into the aperture 310 of the resonator 140 such that the resonator is in contact with the radiator element 110. It is to be appreciated that the shape and size (e.g., discussed in FIG. 4) of the aperture 310 is specific to the performance of low frequency bands and high frequency bands of which the antenna can operate.

Turning to FIG. 4, a top view 400 of the aperture 310 associated with the resonator 140 is illustrated. The top view 400 includes specifications for the aperture 310 associated with the resonator 140. For example, the aperture 310 can include a slot width of approximately 1.20 mm and a slot length of approximately 8.50 mm. It is to be appreciated that such dimensions of the slot width and/or the slot length can be any suitable size and the above is provided solely for example. Moreover, it is to be appreciated that the slot width and/or the slot length of the aperture 310 on the resonator 140 can be adjusted so as to tailor an antenna utilizing such resonator 140 to operate in a desired low frequency band and high frequency band. It is to be appreciated that the aperture 310 may have no electrical significance other than to provide an electro-mechanical connection creating a conductive short between the radiator element 110 and the resonator 140. In other words, the RF current does not pass through the aperture 310 but rather the current passes around the resonator 140.

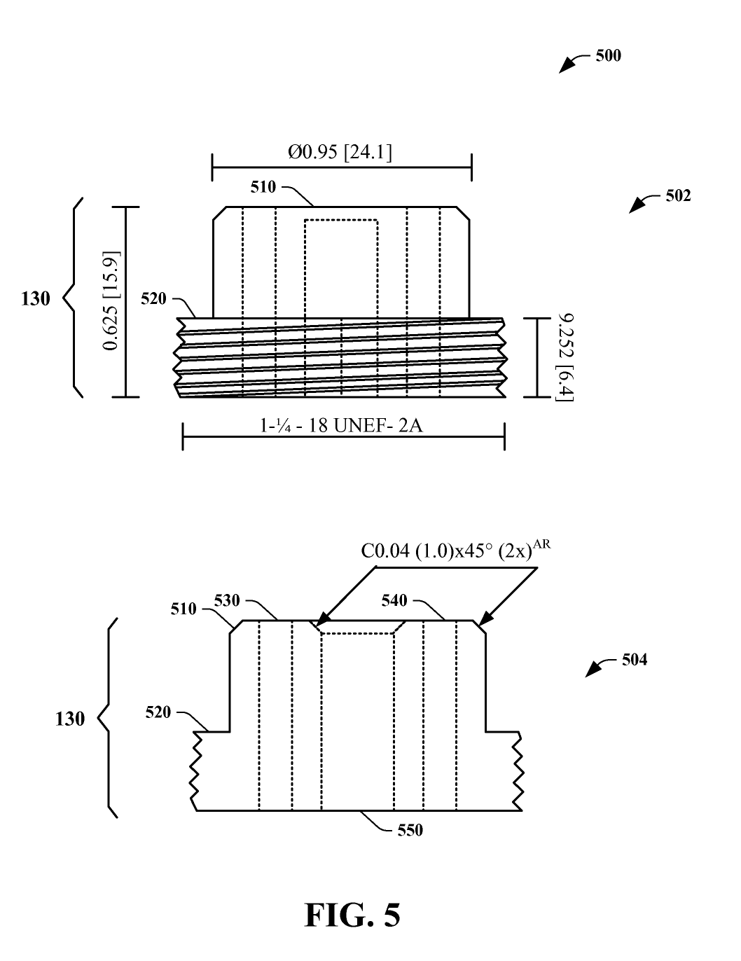

FIG. 5 illustrates a side view 500 of the threaded support bushing 130. A side view 502 includes the threaded support bushing 130 with a top portion 510 and a threaded lower portion 520. It is to be appreciated that the resonator (not shown) is affixed to the top portion 510 for construction of an antenna associated with the subject disclosure. In other words, the resonator (not shown) is fit or placed onto the top portion 510. In particular, the resonator placement is depicted in the cross-section view of FIG. 2. The threaded support bushing 130 can include various dimensions which are determined upon the low and high band of frequencies to which an antenna is to operate. For instance, the top portion 510 of the threaded support bushing 130 can include a length approximately 24.1 mm (e.g., 0.95 inches) and a height of approximately 9.5 mm (e.g., 0.374 inches). Moreover, the bottom portion 520 of the threaded support bushing 130 can include a length of approximately 31.75 mm (e.g., 1.25 inches) and a height of approximately 6.4 mm (e.g., 0.252 inches).

Additionally, a cross section side view 504 is of the threaded support bushing 130. The cross section side view 504 includes the top portion 510 and the threaded lower portion 520. Moreover, the threaded support bushing 130 includes a first cylindrical cavity 530 through the top portion 510 and the threaded lower portion 520 and a second cylindrical cavity 540 through the top portion 510 and the threaded lower portion 520. Furthermore, the threaded support bushing 130 can include a third cylindrical cavity 550 through the top portion 510 and the threaded lower portion 520. It is to be appreciated that the third cylindrical cavity 550 enables the radiator element 110 (discussed above) to be inserted up and through the threaded support bushing 130.

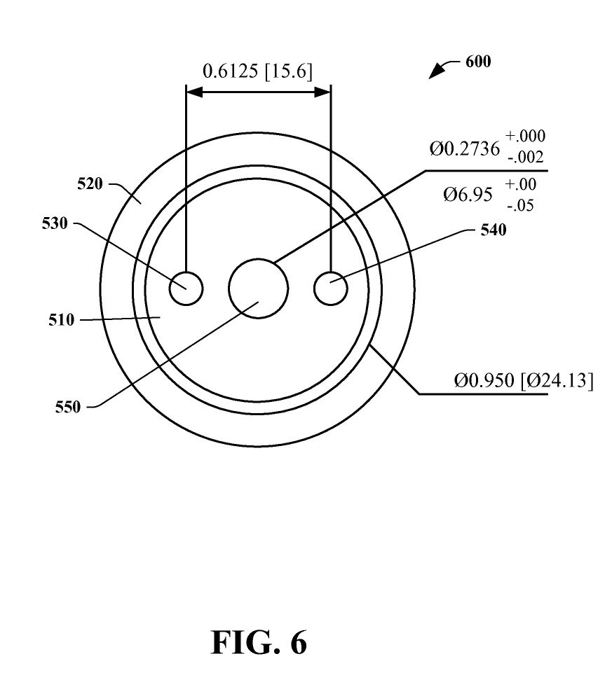

FIG. 6 illustrates a top view 600 of the threaded support bushing 130. The top view 600 of the threaded support bushing 130 can include the top portion 510 and the threaded lower portion 520. Additionally, the first cylindrical cavity 530, the second cylindrical cavity 540, and the third cylindrical cavity 540 are illustrated. A distance between the first cylindrical cavity 530 and the second cylindrical cavity 540 can be approximately 15.6 mm (e.g., 0.6125 inches) (center to center). The third cylindrical cavity 550 can have a diameter of approximately 6.95 mm (e.g., 0.2736 inches. The first cylindrical cavity 530 and the second cylindrical cavity 540 can each respectively have a diameter of approximately 3.2 mm (e.g., 0.126 inches). Moreover, the diameter of the top portion 510 can be approximately 24.13 mm (e.g., 950 inches).

As discussed above, the resonator 140 (not shown) is placed to fit onto the top portion 510 of the threaded support bushing 130. Thus, the dimensions of the top portion 510 and the threaded lower portion 520 can be specifically tailored in order for the resonator to allow current pass-through for a low band of frequencies and a high band of frequencies. In other words, an antenna can be constructed such that a resonator, radiator cap, radiator element, and the threaded support bushing are all customized and tailored to allow operation of such antenna is a desired high band of frequencies and a low band of frequencies. Thus, an antenna can be customized for operation in a low band of frequencies as well as a high band of frequencies without interference of one another.

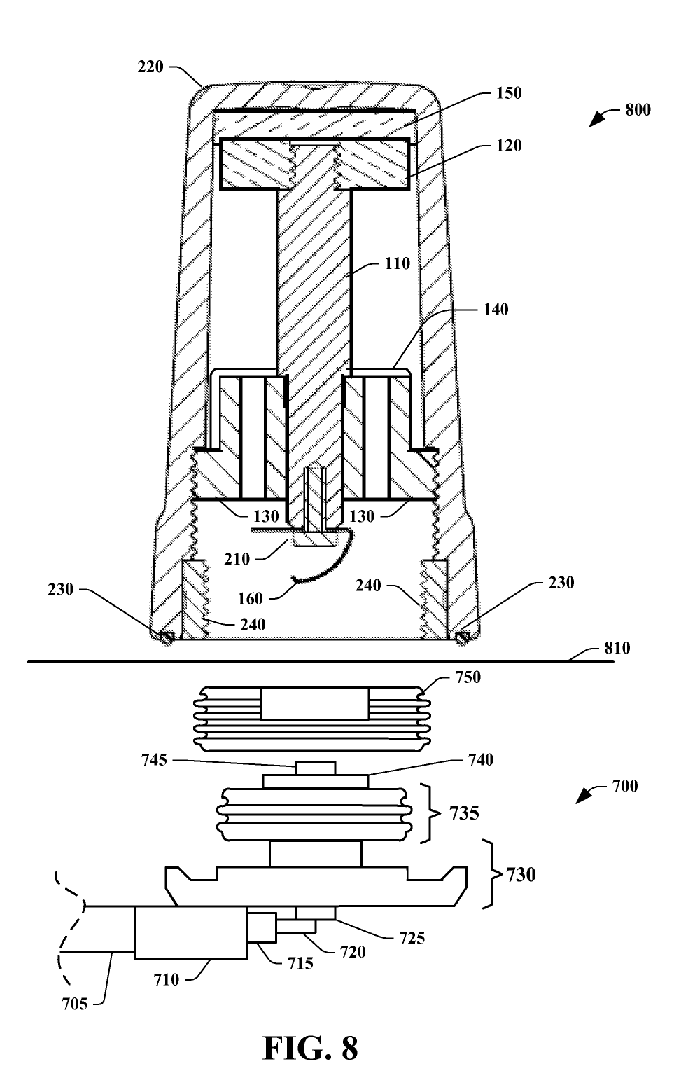

FIG. 7 illustrates a side view of an antenna mount 700 for an antenna. The antenna mount 700 can be physically coupled to an antenna via insert threads (not shown) within a radome housing (not shown but described in more detail in FIG. 8). It is to be appreciated that the antenna mount 700 can be any suitable antenna mount to physically mount an antenna (and associated components) to a surface. By way of example and not limitation, the antenna mount 700 can be a traditional antenna mount such as an NMO mount. In other words, the antenna mount 700 can be any structure or component that enables an antenna to physically connect an antenna to a surface. Thus, any components, aspects, or connecting mechanisms associated with the antenna mount 700 are solely for exemplary purposes and any suitable techniques and/or components are intended to be included with the subject disclosure.

The antenna mount 700 can provide connectivity between a coax cable 705 and an antenna (not shown) via physically connecting the antenna mount 700 to an antenna with a surface there between. In other words, the antenna mount 700 allows transmission or receipt of a signal from the coax cable to and/or from the antenna (not shown). It is to be appreciated that any suitable cable or connective wire can be utilized to physically connect an antenna to a receiver/transmitter and a coax cable is not to be limiting on the subject innovation. By way of example and not limitation, the coax cable 705 includes an outer plastic sheath (shown on the coax cable 705), a woven copper shield (not shown), an inner dielectric insulator 715, and a copper core 720. It is to be appreciated that the woven shield and the core can be any suitable material and are not to be limited to copper. The antenna mount 700 further includes a support connector 710 that clamp or maintain a position of the coax cable 705 to ensure physically stability.

The copper core 720 can be connected to a lower contact 725. By way of example and not limitation, the connection can be soldered. The copper core 720 and the lower contact 725 are connected such that a transfer from the coax cable 705 to the lower contact 725 is approximately ninety (90) degrees (e.g., approximately perpendicular). The antenna mount 700 can include a lower support 730 and an upper support 735. The lower contact 725 can be physically inside the lower support 730 and the upper support 735 to create an upper contact 745 insulated by an insulation component 740. Although it is not illustrated in FIG. 7, a contact (not shown) is inside the lower support 730 and the upper support 735 such that the contact is a cylinder shaped component, wherein surrounding the contact with the upper support 735 and the lower support 730, a side view (as depicted) illustrates the lower contact 725 and the upper contact 745. The antenna mount 700 can further include threaded ring 750 that physically attaches to the upper support 735. By way of example and not limitation, the threaded ring 750 can physically connect to the upper support 735 by use of threads on an inside of the threaded ring 750 and threads on an outside of the upper support 735. As depicted in FIG. 7, the threaded ring 750 can be screwed onto the upper support 735 with a clockwise rotation, although any suitable configuration for threading the threaded ring 750 onto the upper support 735 is intended to be included in this subject disclosure. As will be discussed below, the threaded ring 750 physically connects the antenna mount 700 to an antenna via an insert thread within a radome housing that houses such antenna.

FIG. 8 illustrates an antenna within a radome housing and an antenna mount from a side view 800. The side view 800 depicts a cross-sectional view of the radome housing 220 that includes the radiator element 110, the radiator cap 120, the resonator 140, the threaded support bushing 130, and the contact 160. The side view 800 also depicts the antenna mount 700 discussed above. The threaded ring 750 can physically connect to the upper support 735 of the antenna mount 700 via inner threads on the threaded ring 750 and outer threads on the upper support 735. Moreover, the threaded ring 750 can physically connect the antenna mount 700 to the insert threads 240 associated with the radome housing 220. By way of example and not limitation, the insert threads 240 can physically screw the threaded ring 750 into the radome housing securing the antenna mount to the radome housing 220 with a surface 810 there between. Moreover, a connection is maintained during this physical connection from the contact 160 to the upper contact 745 to the lower contact 725 to the copper core 720 to a transmitter/receiver component (not shown).

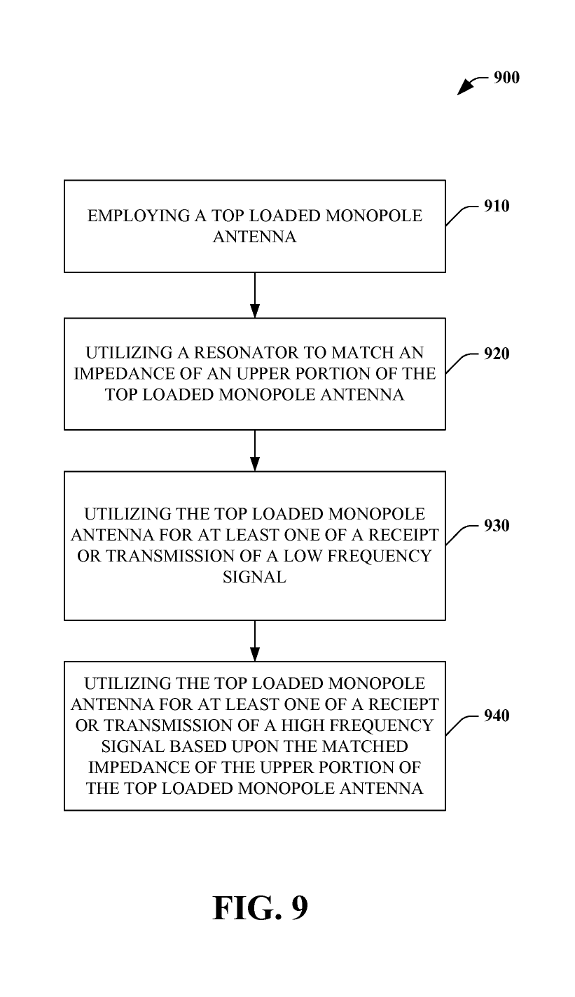

FIGS. 9-11 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 is a method 900 of communicating multi-band frequencies. At reference numeral 910, a top loaded monopole antenna is employed. At reference numeral 920, a resonator is utilized to match an impedance of an upper portion of the top loaded monopole antenna. At reference numeral 930, the top loaded monopole antenna is utilized for at least one of a transmission or a receipt of a low frequency signal. At reference numeral 940, the top loaded monopole antenna is utilized for at least one of a transmission or a receipt of a high frequency signal based upon the matched impedance of the upper portion of the top loaded monopole antenna.

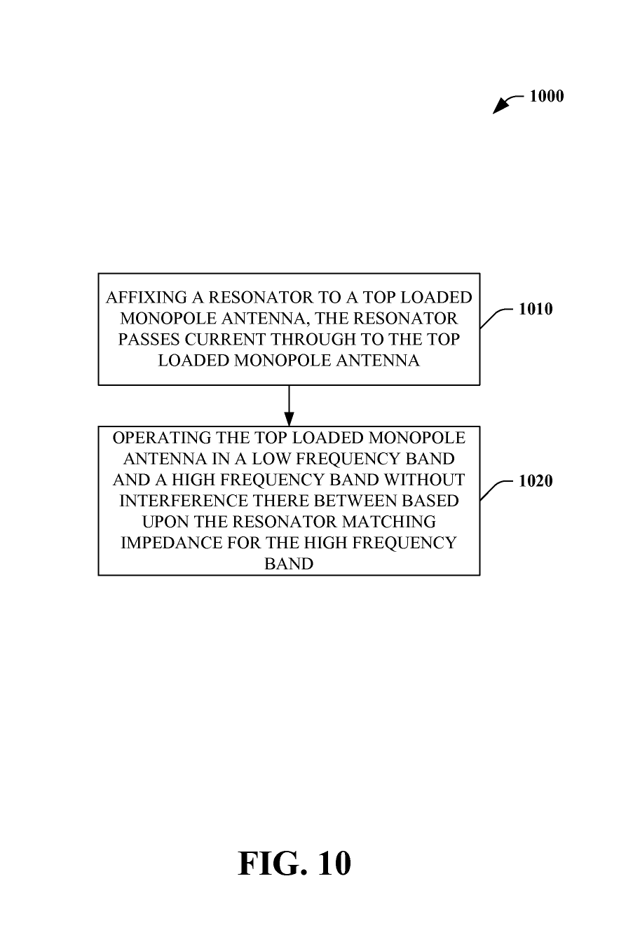

FIG. 10 is a flow chart diagram of a method 1000 of matching impedance in order to operate an antenna in a high frequency band and a low frequency band. At reference numeral 1010, a resonator can be affixed to a top loaded monopole antenna in which the resonator passes current through the top loaded monopole antenna. In particular, the top loaded monopole antenna can include a threaded support bushing that includes an inserted radiator element, wherein the radiator element is connected to a radiator cap to form the top loaded monopole antenna. The resonator can be affixed on top of the threaded support bushing and in contact with the radiator element. The resonator enables current to pass through the top loaded monopole antenna. Moreover, the resonator matches impedance for a high frequency band.

At reference numeral 1020, the top loaded monopole antenna can operate in a low frequency band and a high frequency band without interference from one another based upon the resonator matching impedance for the high frequency band and current pass-through. In particular, the resonator allows current pass-through such that an upper portion of the top loaded monopole antenna (e.g., from the resonator to the radiator cap) to transmit and/or receive high frequency bands whereas the entire top loaded monopole antenna (e.g., from the contact to the radiator cap) to transmit and/or receive low frequency bands.

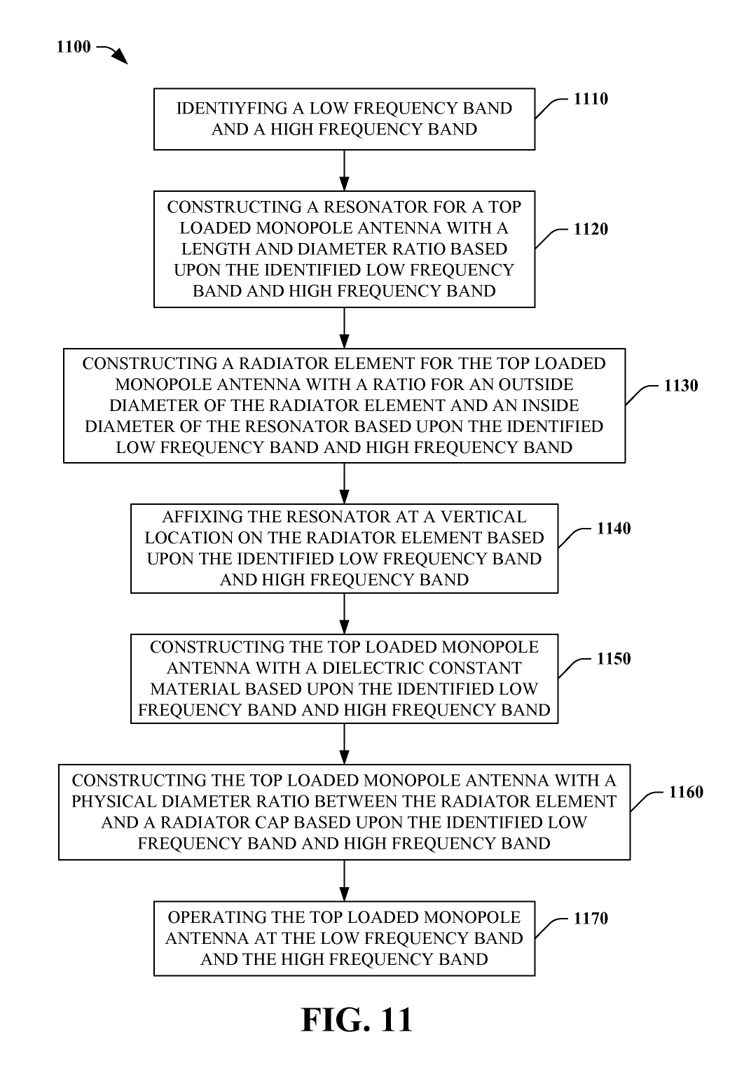

FIG. 11 is a flow chart diagram of a method of customizing a top loaded monopole antenna to operate within a specific high frequency and a specific low frequency. At reference numeral 1110, a low frequency band and a high frequency band can be identified. In particular, the low frequency band can be any band of frequencies approximately below 1 GHz and the high frequency band can be any band of frequencies approximately above 1 GHz. At reference numeral 1120, a resonator for a top loaded monopole antenna can be constructed with a length and diameter ratio based upon the identified low frequency band and high frequency band. By way of example and not limitation, the resonator L/D ratio can be approximately 0.37. It is to be appreciated that any suitable ratio is included in this subject disclosure in order to target the identified low frequency band and high frequency band and the ratio of 0.37 is solely for exemplary purposes.

At reference numeral 1130, a radiator element for the top loaded monopole antenna can be constructed with a ratio for an outside diameter (OD) of the radiator element and resonator, and an inside diameter (ID) of the resonator based upon the identified low frequency band and high frequency band. By way of example and not limitation, the ratio between the resonator ID to the radiator element 1100D ratio can be in the range of approximately 3.45 to approximately 3.55. It is to be appreciated that any suitable ratio is included in this subject disclosure in order to target the identified low frequency band and high frequency band and the ratio range of approximately 3.45 to approximately 3.55 is solely for exemplary purposes.

At reference numeral 1140, the resonator can be affixed to a vertical location on the radiator element based upon the identified low frequency band and high frequency band. By way of example and not limitation, the vertical location of the resonator can be at approximately 19.7 mm from a feed point location referenced between a contact and the radiator element interface location. It is to be appreciated that any suitable vertical location is included in this subject disclosure in order to target the identified low frequency band and high frequency band and the vertical location of approximately 19.7 mm from a feed point is solely for exemplary purposes.

At reference numeral 1150, the top loaded monopole antenna can be constructed with a dielectric constant material based upon the identified low frequency band and high frequency band. By way of example, the dielectric constant material can be a threaded support bushing which can be machined from, for example, Polyoxymethylene (POM) material (also referred to as Delrin™)

At reference numeral 1160, the top loaded monopole antenna can be constructed with a physical diameter ratio between the radiator element and a radiator cap based upon the identified low frequency band and high frequency band. By way of example and not limitation, the physical diameter ratio (D/d) of the top loaded monopole (e.g., radiator cap) to radiator element can be approximately 2.5 to approximately 2.6. It is to be appreciated that any suitable ratio is included in this subject disclosure in order to target the identified low frequency band and high frequency band and the ratio of approximately 2.5 to approximately 2.6 is solely for exemplary purposes.

At reference numeral 1170, the top loaded monopole antenna can operate in the low frequency band and the high frequency band without interference between the two bands based upon the construction parameters and inclusion of the resonator. In other words, the top loaded monopole antenna can transmit and/or receive signals from the low frequency band and the high frequency band.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), Global System for Mobile Communications (GSM), and other systems. The terms “system” and “network” are often used interchangeably.

Furthermore, various embodiments are described herein in connection with a mobile device. A mobile device can include an antenna for communication and can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, a tablet computer, computing device, a communication device with an antenna, or other processing device connected to a wireless modem. Moreover, various embodiments are described herein in connection with a base station. A base station can be utilized for communicating with mobile device(s) and can also be referred to as an access point, Node B, or some other terminology.

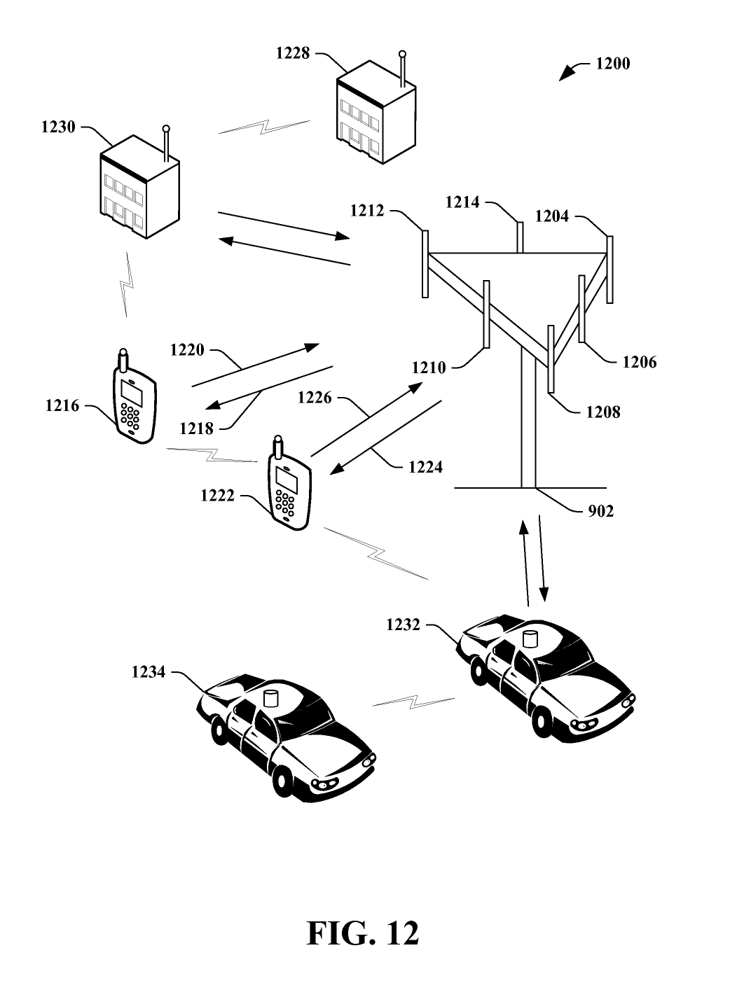

Referring now to FIG. 12, a wireless communication system 1200 is illustrated. System 1200 can include a base station 1202 that can include multiple antenna groups. For example, a first antenna group can include antennas 1204 and 1206, a second antenna group can comprise antennas 1208 and 1210, and an additional antenna group can include antennas 1212 and 1214. By way of example and not limitation, two antennas are illustrated for each antenna group; however, more or fewer antennas can be utilized for each group. Base station 1202 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

By way of example and not limitation, the base station 1202 can communicate with one or more mobile devices such as mobile device 1216 and mobile device 1222; however, it is to be appreciated that the base station 1202 can communicate with substantially any number of mobile devices similar to mobile devices 1216 and 1222. Mobile devices 1216 and 1222 can be, for example, cellular phones, smart phones, laptops, handheld communication devices, handheld computing devices, satellite radios, global positioning systems, PDAs, tablet computers, and/or any other suitable device for communicating over wireless communication system 1200. Moreover, each mobile device can utilize an antenna for communication. As depicted, mobile device 1216 is in communication with antennas 1212 and 1214, where antennas 1212 and 1214 transmit information to mobile device 1216 over a forward link 1218 and receive information from mobile device 1216 over a reverse link 1220. Similarly, mobile device 1222 is in communication with antennas 1204 and 1206, where antennas 1204 and 1206 transmit information to mobile device 1222 over a forward link 1224 and receive information from mobile device 1222 over a reverse link 1226.

Each group of antennas and/or the area in which they are designated to communicate can be referred to as a sector of base station 1202. For example, antenna groups can be designed to communicate to mobile devices in a sector of the areas covered by base station 1202. In communication over forward links 1218 and 1224, the transmitting antennas of base station 1202 can utilize beamforming to improve signal-to-noise ratio of forward links 1218 and 1224 for mobile devices 1216 and 1222. Also, while base station 1202 utilizes beamforming to transmit to mobile devices 1216 and 1222 scattered randomly through an associated coverage, mobile devices in neighboring cells can be subject to less interference as compared to a base station transmitting through a single antenna to all its mobile devices.

Base station 1202 (and/or each sector of base station 1202) can employ one or more multiple access technologies (e.g., CDMA, TDMA, FDMA, OFDMA, . . . ). For instance, base station 1202 can utilize a particular technology for communicating with mobile devices (e.g., mobile devices 1216 and 1222) upon a corresponding bandwidth. Moreover, if more than one technology is employed by base station 1202, each technology can be associated with a respective bandwidth. The technologies described herein can include following: Specialized Mobile Radio (SMR) Integrated Digital Enhancement Network (iDEN), Advance Mobile Phone System (AMPS), Global System for Mobile Communications (GSM), IS-95 (CDMA), IS-136 (D-AMPS), International Mobile Telecommunications-2000 (IMT-2000) (also referred to as 3G), Fourth Generation Cellular Wireless Standards (4G), MediaFlo, Digital Video Broadcasting-Handheld (DVB-H), Long Term Evolution (LTE), etc. It is to be appreciated that the aforementioned listing of technologies is provided as an example and the claimed subject matter is not so limited; rather, substantially any wireless communication technology is intended to fall within the scope of the hereto appended claims.

As mentioned, each mobile device can include an antenna to transmit and/or receive signals. The wireless communication system 1200 further includes a building 1228 with a fixed antenna for communication, a building 1230 with a fixed antenna for communication, an automobile 1232 with a mobile antenna for communication, and an automobile 1234 with a mobile antenna for communication. As depicted in the wireless communication system 1200, the antenna, fixed or mobile, can communicate with the base station 1202. Furthermore, the fixed antenna associated with the building 1228 can communicate with the fixed antenna associated with the building 1230. Additionally, the mobile antenna related to the automobile 1232 can communicate with the mobile antenna related to the automobile 1234. It is to be appreciated that the fixed antenna associated with the building 1228 and/or the building 1230 can communicate with the mobile antenna associated with the automobile 1232 and/or the automobile 1234. For instance, the automobile 1232 with the mobile antenna can communicate directly with the building 1228 with the fixed antenna (e.g., push-to-talk, etc.). In general, the antenna can be associated with any mobile device or communication device and can transmit and/or receive signals between each other independent of antenna type or device utilizing such antenna. For example, the antenna communication can be fixed, mobile, fixed to mobile, mobile to fixed, mobile to mobile, fixed to fixed, etc.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the subject disclosure, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software. It is to be appreciated that the system 1300 can utilize declarative rules to extend and/or specialize at least one engine process(es).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An antenna, comprising:
a radiator element that includes a top portion and a bottom portion;
a radiator cap coupled to the top portion of the radiator element to form a top loaded monopole antenna, the top loaded monopole antenna transmits a low frequency signal;
a threaded support bushing that includes a top portion and a bottom threaded portion, the threaded support bushing is coupled to the bottom portion of the radiator element;
a resonator affixed to the top portion of the threaded support bushing that implements a half-wave length resonance between the resonator and the radiator cap, the resonator matches an impedance of the radiator cap for transmission of a high frequency signal;
the resonator is in contact with the bottom portion of the radiator element; and
the threaded support bushing employs a dielectric loading between the resonator and the radiator element.

2. The antenna of claim 1 further comprises a radome housing that encases the radiator element, the radiator cap, the threaded support bushing, and the resonator.

3. The antenna of claim 1, the high frequency is a frequency above 1 GHz.

4. The antenna of claim 1, the low frequency is a frequency below 1 GHz.

5. The antenna of claim 1 further comprises an antenna mount that couples the antenna to a perpendicular surface, the resonator matches an impedance of the antenna mount.

6. The antenna of claim 5, the antenna mount is an NMO mount.

7. The antenna of claim 1, the high frequency is approximately 1.9 to 3.0 times the low frequency.

8. The antenna of claim 1 further comprises:
the resonator includes a length and an outer diameter;
the resonator includes a length to outer diameter ratio of approximately 0.37;
the radiator element includes an outer diameter;
the resonator includes an inner and an outer diameter; and
a ratio between the inner and the outer diameter of the resonator and the outer diameter of the radiator is in a range of approximately 3.45 to approximately 3.55.

9. The antenna of claim 1 further comprises:
the top loaded monopole antenna transmits the low frequency signal; and
the resonator matches the impedance of the radiator cap to receive the high frequency signal.

10. The antenna of claim 1 further comprises:
the top loaded monopole antenna receives the low frequency signal; and
the resonator matches the impedance of the radiator cap for transmission of the high frequency signal.

11. An antenna, comprising:
a radiator element that includes a top portion and a bottom portion;
a radiator cap coupled to the top portion of the radiator element to form a top loaded monopole antenna, the top loaded monopole antenna receives a low frequency signal;
a threaded support bushing that includes a top portion and a bottom threaded portion, the threaded support bushing is coupled to the bottom portion of the radiator element;
a resonator affixed to the top portion of the threaded support bushing that implements a half-wave length resonance between the resonator and the radiator cap, the resonator matches an impedance of the radiator cap to receive a high frequency signal; and
the threaded support bushing employs a dielectric loading between the resonator and the radiator element.

12. The antenna of claim 11 further comprises an antenna mount that couples the antenna to a perpendicular surface, the resonator matches an impedance of the antenna mount

13. The antenna of claim 11, the high frequency is a frequency above 1 GHz and the low frequency is a frequency below 1 GHz.

14. The antenna of claim 11 further comprises at least one of the following:
the top loaded monopole antenna transmits the low frequency signal;
the resonator matches the impedance of the radiator cap to receive the high frequency signal;
the top loaded monopole antenna receives the low frequency signal; and
the resonator matches the impedance of the radiator cap for transmission of the high frequency signal.

15. A method for an antenna, comprising:
employing a top loaded monopole antenna;
utilizing a resonator to match an impedance of an upper portion of the top loaded monopole antenna;
utilizing the top loaded monopole antenna for at least one of a transmission or a receipt of a low frequency signal; and
utilizing the top loaded monopole antenna for at least one of a receipt or transmission of a high frequency signal based upon the matched impedance of the upper portion of the top loaded monopole antenna.

16. The method of claim 15, the low frequency is below 1 GHz and the high frequency is above 1 GHz.

17. The method of claim 15, matching an impedance of an antenna mount with the resonator.

18. The method of claim 15, utilizing the top loaded monopole antenna with a low frequency within a range of 700 MHz to 960 MHz and with a high frequency within the range of 1000 MHz to 2500 MHz.

19. The method of claim 15, further comprising:
radiating the low frequency signal between a feed point and the top loaded monopole antenna; and
radiating the high frequency between the resonator and the upper portion of the top loaded monopole antenna.

20. The method of claim 19, further comprising:
receiving the low frequency signal between a feed point and the top loaded monopole antenna; and
receiving the high frequency between the resonator and the upper portion of the top loaded monopole antenna.
